(19) United States
(12) Patent Application Publication
(10) Pub. No.: US 2016/0371755 A1
(43) Pub. Date: Dec. 22, 2016

(54) CUSTOMER MOVEMENT MONITORING SYSTEM AND METHOD

(71) Applicant: Wal-Mart Stores, Inc., Bentonville, AR (US)

(72) Inventors: Donald R. High, Noel, MO (US); Brian Gerard McHale, Oldham (GB)

(21) Appl. No.: 15/180,708

(22) Filed: Jun. 13, 2016

Related U.S. Application Data
(60) Provisional application No. 62/180,231, filed on Jun. 16, 2015.

(51) Int. Cl. G06Q 30/06; G06Q 90/00; H04W 4/04

(52) U.S. Cl. CPC G06Q 30/0613; H04W 4/04; G06Q 90/20

(57) ABSTRACT

Provided are a system and method for monitoring customer movement in a retail environment, comprising: a location determiner configured to determine a location of a customer device in the retail environment; an in-store device configured to be operated by a member of staff, and configured to receive and display a customer arrival notification, and a controller configured to, when the location determiner determines that the customer device has entered the retail environment, transmit a customer arrival notification to the in-store device.

### RELATED APPLICATIONS

This application claims priority to U.S. Provisional Patent Application Ser. No. 62/180,231 to Walmart Stores Inc., filed Jun. 16, 2015 and entitled “Customer Movement Monitoring System and Method”, which is hereby incorporated entirely herein by reference.

### FIELD OF THE INVENTION

This invention relates to customer movement monitoring systems and methods.

### BACKGROUND

Increasingly, modern retailers rely not only on purchases made in store, but also on purchases made remotely, for example over the internet or by telephone. Often, remote purchases are delivered to the residence of the customer. However, in some instances it is preferable for the customer to instead travel to the store to pick up the purchased items. For example, it may be that home delivery requires the customer to be in their residence at a particular time which is not convenient, such as during normal working hours. The increasingly long opening hours and convenient out-of-town locations of typical retail stores means that it may be easier for the customer to travel to store and collect the item rather than wait at home for the item to be delivered. Alternatively, it may be that the customer has ordered a particular item—for example an item of clothing or an item of electrical goods—and wishes to collect that item at the same time as purchasing groceries.

Typically, a customer picking up an order in retail store will bring with them a printed confirmation of their order which may include an order number, and travel to a specified order collection point in the store. A member of staff at the order collection point will verify the details of the order, and then go retrieve the items, either from a stock room or warehouse, or from the shop floor. The customer must wait at or near the order collection point until the member of staff returns with the ordered goods.

Furthermore, customers browsing in a retail store may often require assistance from a member of staff, e.g. to find a particular product, to ask questions about products or to acquire some other information. Typically, a customer walks around the store until they happen upon a member of staff. However, it can be difficult for the customer to find a member of staff to assist them. This is particularly the case at times when the store is very busy and so most staff are otherwise engaged, or at times when the store is quiet and the staffing level is accordingly low, such as late at night. This difficulty may be exacerbated in large retail stores.

It is an aim of the present invention to address at least some of the above difficulties, or other difficulties which will be appreciated from the description below. It is a further aim of the present invention to provide convenient, accurate and cost effective systems and methods for monitoring the movement of customers in a retail store.

### SUMMARY

According to the present invention there is provided an apparatus and method as set forth in the appended claims. Other features of the invention will be apparent from the dependent claims, and the description which follows.

In one embodiment the invention has a system for monitoring customer movement in a retail environment, comprising: a location determiner configured to determine a location of a customer device in the retail environment; an in-store device configured to be operated by a member of staff, and configured to receive and display a customer arrival notification, and a controller configured to, when the location determiner determines that the customer device has entered the retail environment, transmit a customer arrival notification to the in-store device.

Suitably, the customer device is configured to receive and display an entry confirmation notification, and the controller is configured to, when the location determiner determines that the customer device has entered the retail environment, transmit the entry confirmation notification to the customer device.

Suitably, the entry confirmation notification comprises a meeting point location and the customer device is configured to display the meeting point location on a map of the retail environment.

Suitably, the controller is configured to calculate the meeting point location based on the determined location of the customer device and a location of the in-store device.

Suitably, the location determiner is further configured to determine a location of the in-store device in the retail environment, and the entry confirmation notification comprises the determined location of the in-store device.

Suitably, the customer device is configured to display the determined location of the in-store device on a map of the retail environment.

Suitably, the controller is configured to receive order pick-up information from the customer device, and customer arrival notification comprises the order pick-up information.

Suitably, the customer arrival notification includes the determined location of the customer device.

Suitably, the in-store device is configured to display the determined location of the customer device on a map of the retail environment.

Suitably, the location determiner comprises: a plurality of emitters operable to emit modulated light, and a receiver operable to measure a quantity of modulated light received from each respective emitter, so as to determine the location, wherein the customer device comprises the receiver.

In one embodiment the invention has a method of monitoring customer movement in a retail environment, comprising: determining that a customer device has entered the retail environment; transmitting a customer arrival notification to an in-store device configured operated by a member of staff, and displaying the customer arrival notification on the in-store device.

Suitably, the method further comprises: transmitting an entry confirmation notification to the customer device, and displaying the entry confirmation notification on the customer device.

Suitably, the method further comprises determining a location of the in-store device in the retail environment, wherein the entry confirmation notification comprises the determined location of the in-store device.

Suitably, the method further comprises displaying the determined location of the in-store device on a map of the retail environment, on the customer device.

Suitably, the method further comprises receiving order pick-up information from the customer device, wherein the customer arrival notification comprises the order pick-up information.

Suitably, the customer arrival notification includes a location of the customer device.

Suitably, the method further comprises displaying, on the in-store device, the location of the customer device on a map of the retail environment.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a schematic view of a retail store in which an exemplary system for monitoring customer movement may operate;

FIG. 2 is a schematic view of an exemplary system for monitoring customer movement;

FIGS. 3A-3C are each an exemplary user interface of a customer device of an exemplary system for monitoring customer movement;

FIG. 4 is an exemplary user interface of an in-store device of an exemplary system for monitoring customer movement, and

FIG. 5 is a flowchart of an exemplary method of monitoring customer movement in a retail environment.

### DETAILED DESCRIPTION

In overview, embodiments of the present invention provide a system configured to determine that a portable device held by a customer has entered a retail store, and accordingly transmit a notification to an in-store device operated by a member of retail store staff. In some embodiments, the customer device is configured to send information to the in-store device regarding an order to be collected, so that the member of retail store staff can prepare the order before the customer arrives at an order collection point. In some embodiments, the in-store device and customer device receive information regarding each others location in store, so that the member of staff and the customer can easily locate each other.

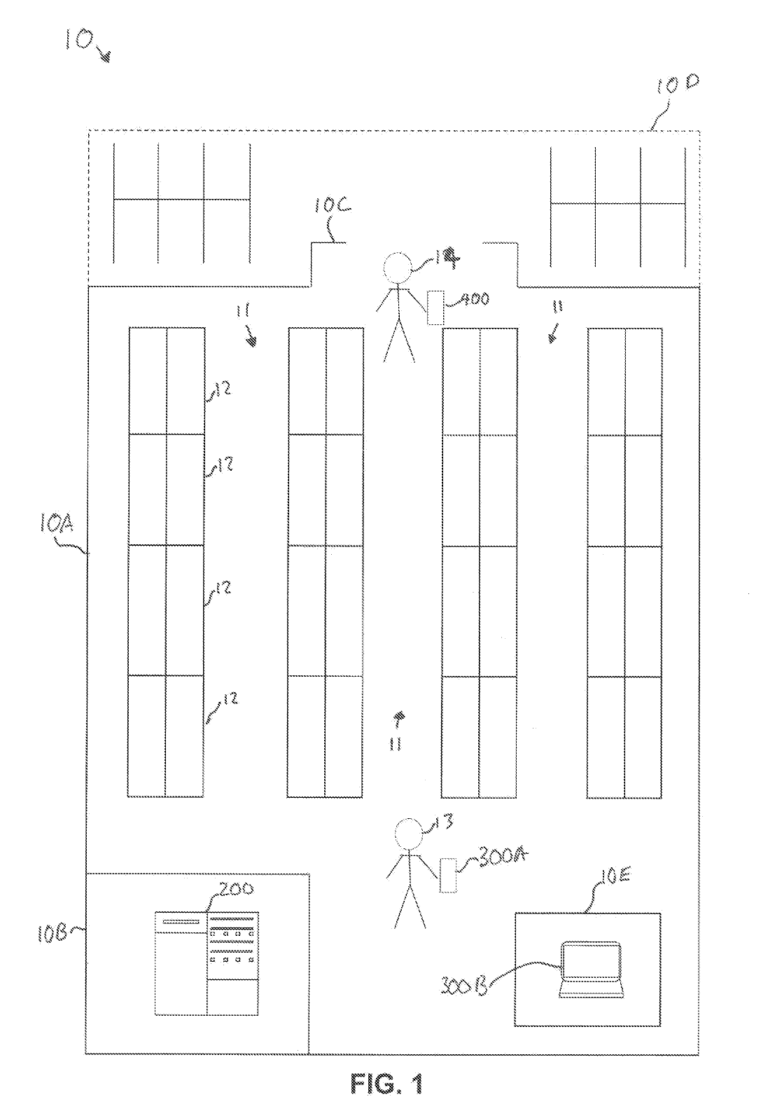

FIG. 1 shows a schematic view of a physical environment in which embodiments of the invention may operate. In one example, the physical environment is a retail store 10. The retail store 10 typically comprises a sales area 10A, in which goods are displayed for customers to purchase, and an operational area 10B, in which further stock may be held, and in which infrastructure for the operation and maintenance of the retail store is installed. The premises of the retail store 10 typically extend to an outdoor area 10D proximate to the retail store 10, such as a car park. The retail store 10 comprises at least one entrance 10C, through which customers enter and exit the retail store 10C from the outdoor area 10D.

In one example, the operational area 10B includes a server 200, which will be described in further detail below. It will be understood by those skilled in the art that the retailer's computer network may in practice comprise hundreds of stores with various local servers linked to one or more central control computers operated by the retail, e.g. in the head office of the retailer.

The sales area 10A typically includes a plurality of aisles 11, wherein each aisle 11 further comprises a plurality of storage units 12. The storage units 12 are arranged to hold products for sale in the retail store 10, and may comprise a plurality of shelves (not shown). It will be understood that a variety of storage units 12 may be employed, including storage units arranged on the end of aisles, arranged to stand freely, and arranged to refrigerate the products held therein.

FIG. 1 shows a member of retail store staff 13, carrying an in-store device 300A, which will be described in further detail below.

FIG. 1 also shows a customer 14 carrying a customer device 400, which will be described in further detail below. Typically, the customer 14 moves around the sales area 10A, progressing up and down the aisles 11 and selecting the products that they wish to purchase. Once they have selected the products they desire, they pay for the products at a checkout (not shown).

The sales area 10A further comprises an order collection point 10E, where a customer 14 may present themselves in order to collect pre-ordered goods. The order collection point 10E may comprise a further in-store device 300B, in addition to or as an alternative to the in-store device 300A carried by the member of retail store staff 13.

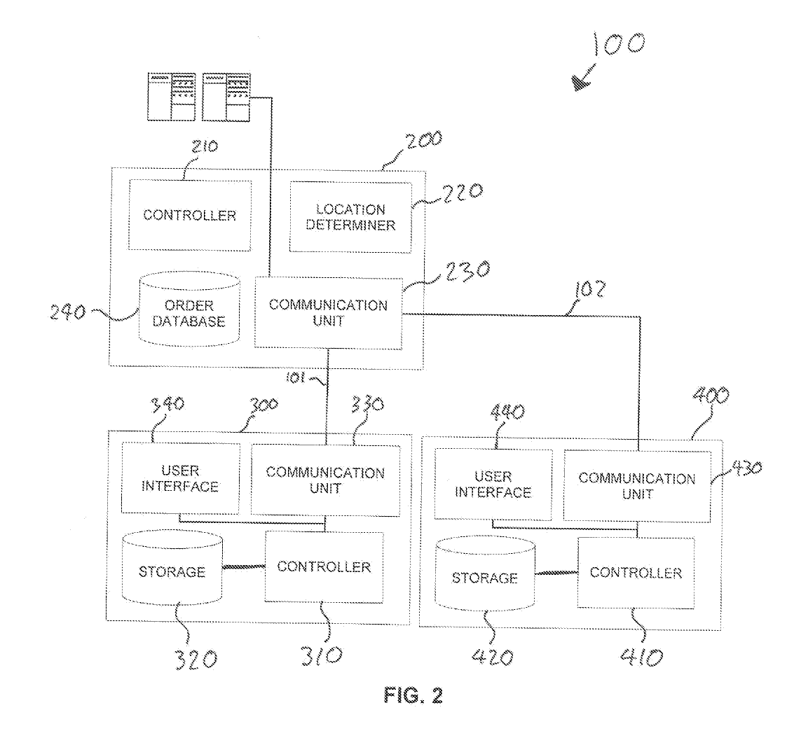

FIG. 2 shows a schematic diagram of a system for monitoring customer movement in a retail environment 100.

In one example, the system 100 comprises a location determiner 220, a controller 210 and an in-store device 300. In one example, the server 200 comprises the location determiner 220 and the controller 210. The system 100 is configured to interact with a customer device 400.

In one example, the server 200 and the in-store device 300 are linked by a communication network 101. The communication network 101 may take any suitable form, including secure wired and/or wireless communication links, as will be familiar to those skilled in the art. In further examples, the server 200 may be located off-site, for example in a central or regional data processing site, rather than in the operational area 10B. In such an example, the communication network 101 may include a wide area network, such as a private leased line and/or the Internet. The server 200 comprises a communication unit 230, which is configured to manage the communications over the network 101 to/from the in-store device 300.

In one example, the server 200 and the customer device 400 are linked by a communication network 102. The communication network 102 may take any suitable form, including secure wired and/or wireless communication links, as will be familiar to those skilled in the art. In one example, the communication network 102 is the same network as the communication network 102. The communication unit 230 is further configured to manage the communications over the network 102 to/from the customer device 400.

In one example, the communication unit 230 may also manage communications between the server 200 other connected server computers operated by the retailer, thereby forming part of a corporate server network.

In one example, the server 200 further comprises an order database 240, configured to store order information relating to customer orders placed remotely, such as over the Internet. In one example, the order information may relate customer identity information, such as a customer ID number, to the stored order information relating to one or more orders which have been placed by the customer. In one example, the order information may relate a unique order number to an order which has been placed by a customer. Each order may comprise a list of goods, which may be identifies by suitable codes (e.g. universal product codes or stock keeping unit codes). The order information held in the order database 240 may be received from another server, e.g. a server at a head office.

The in-store device 300 is a computing device configured to be operated by a member of retail store staff 13. In one example, the in-store device 300 is a portable or wearable device 300A adapted to be carried or worn by a user whilst in use. In one example, the in-store device 300A is one of a tablet computer, a smart phone, a smart watch or smart glasses. In a further example, the in-store device 300 may be a computing device configured as a terminal 300B, fixedly positioned within the retail store 10, for example at the order collection point 10E. In one example, the in-store device 300B is a personal computer.

In one example, the in-store device 300 includes a controller 310, a storage 320, a communication unit 330 and a user interface 340.

The controller 310 is operable to control the in-store device 300, and may take the form of a processor. The storage 320 is operable to store, either transiently or permanently, any relevant data required for the operation and control of the in-store device 300. The communication unit 330 is operable to manage communications with the server 300 over the communication network 101.

The user interface 340 is configured to output information to a user and to receive inputs from a user via one or more interfaces. In one example, the user interface 340 comprises a display, operable to display images and text to the user. In one example, the display may be integral to the in-store device 300, but it is not limited thereto. In examples where the in-store device 300 comprises smart glasses, the display may be a Heads-Up Display on the glasses or otherwise projected into the field of view of the user.

In one example, the user interface 340 comprises a means of receiving the user input, such as a keyboard or a touch-screen unit. In one example, the user interface 340 is a touch-screen interface, in which the display and means of receiving user input are integrated. In further examples, the user interface 340 may receive user input by means of voice activation, gesture recognition or any other suitable means. The user interface 340 may also be operable to receive user input from a combination of these sources.

The customer device 400 is a computing device operated by a customer 14. In one example, the customer device 400 is a portable or wearable device adapted to be carried or worn by the customer whilst in use. Particularly, the customer device 400 may be a device owned and routinely carried by the owner. In one example, the customer device 400 is one of a tablet computer, a smart phone, a smart watch or smart glasses.

In one example, the customer device 400 comprises a controller 410, a storage 420, a communication unit 430 and user interface 440. These elements are analogous to the corresponding elements of the in-store device 300 and therefore the description thereof is not repeated.

The location determiner 220 is configured to determine the location of the customer device 400. In one example, the location determiner 220 is further configured to determine the location of the in-store device 300.

The location determiner 220 may use a suitable indoor positioning system to establish the position of the customer device 400 and/or the in-store device 300. The indoor positioning system may extend to the outdoor area 10D, so that the position of the device 400/300 may be determined therein. The determined location may comprise co-ordinates representing a position of the customer device 400 or in-store device 300 on a map of the retail store 10.

In one example, the indoor positioning system may be based on modulated visible light. Particularly, a plurality of LED lights configured to emit modulated visible light may be installed within the retail store 10. In one example, the LED lights may also be installed in the outdoor area 10D. The device 400/300 may comprise one or more photo receivers, e.g. cameras, operable to receive the modulated visible light. In such an example, the location determiner 220 is configured to determine the location based on the relative quantity of light received from one or more of the plurality of LED lights. In one example, the LED lights are light fixtures produced by ByteLight™.

In one example, the indoor positioning system may comprise locator beacons, for example Bluetooth® Low Energy beacons. The location determiner 220 may determine location using one or more of the locator beacons, for example based on relative signal strength, or based on each beacon covering a certain predetermined area of the retail store 10.

In further examples, the indoor positioning system may employ the Global Positioning System (GPS), Wi-Fi, Near-Field Communication (NFC) or any other suitable positioning technology. It will be understood that the location determiner 220 may employ a plurality of positioning technologies, e.g. depending on the level of granularity required, or to provide a fall back in case of technical problems.

Although the location determiner 220 has been described as part of the server 200, it will be understood that, in further examples, at least a part of the location determiner 220 could instead be provided as part of the customer device 400 and/or the in-store device 300. For example, the respective devices 400/300 may be configured to determine their own position within the store and transmit that determined location to the location determiner 220 of the server 200.

In examples where the in-store device 300 is a terminal device 300B fixedly positioned within the retail store 10, the location determiner 220 may store the co-ordinates of the terminal 300B, rather than determining them.

The location determiner 220 is further configured to determine that the customer device 400 has entered the premises of the retail store 10. In one example, the location determiner 220 stores the position of the entrance 10C, and is configured to compare the determined location of the customer device 400 to the stored position of the entrance 10C. It will be understood that the retail store 10 may comprise multiple entrances 10C, and the determined location may be compared to the position of the multiple entrances 10C to determine if the customer device 400 is located within the premises of the retail store 10. In one example, the location determiner 220 stores the positions of the perimeter of the outdoor area 10D, and is configured to compare the determined location of the customer device 400 to the perimeter position. Accordingly, it may be determined that the customer device 400 has entered the outdoor area 10D rather than the sales area 10A.

The controller 210 is configured to control the communication between the in-store device 300, the customer device 400 and the server 200 by transmitting and receiving relevant notifications and messages. In one example, the controller 210 is configured to transmit a customer arrival notification to the in-store device 300 when the location determiner 220 determines that the customer device 400 has entered the premises of the retail store 10. The customer arrival notification comprises relevant information regarding the customer device 400. In one example, the customer arrival notification comprises the determined location of the customer device 400.

In one example, the controller 210 is further configured to receive order pick-up information from the customer device 400. The order pick-up information corresponds to an order to be picked up by the customer 14 operating the customer device 400. In one example, the order pick-up information comprises an order number or a customer number, which identifies the order to be collected. In one example, the controller 210 includes the order pick-up information in the customer arrival notification. In one example, the controller 210 is configured to query the order database 240 for further details regarding the order—for example the list of items which comprise the order. These further details are then also included in the customer arrival notification. Accordingly, the member of staff 13 operating the in-store device 300 is alerted to the presence of the customer 14 coming to collect the order, and the details of the order itself.

In one example, the controller 210 is configured transmit an entry confirmation notification to the customer device 400. The entry confirmation notification alerts the customer 14 carrying the customer device 400 that they have entered the premises of the retail store 10. In one example, the entry confirmation notification includes the location of the in-store device 300. Accordingly, the customer device 400 receives the location of a relevant member of staff 13, or the location of the order collection point 10E.

In one example, the controller 210 is configured to include a meeting point location in the customer arrival notification and/or the entry confirmation notification. The meeting point location may represent a convenient location at which the customer 14 and the member of staff 13 should meet, for example, so that the customer 14 may collect an order or seek other assistance from the member of staff 13.

In one example, the controller 210 is configured to calculate the meeting point location, based on the determined location of the customer device 400 and the determined location of the in-store device. Particularly, the controller 210 is configured to identify a suitable location in the retail store 10 which is approximately equidistant from the determined locations of the customer device 400 and the in-store device 300.

In use, a customer 14 carrying a customer device 400 enters the retail store 10 through the entrance 10C. The location determiner 220 determines that the customer device 400 has entered the retail store 10C, for example by determining the location of the customer device 400 and comparing that to a stored location of the entrance 10C. It will be understood that the determination could be instead that the customer device has entered the outdoor area 10D, or any other appropriate area.

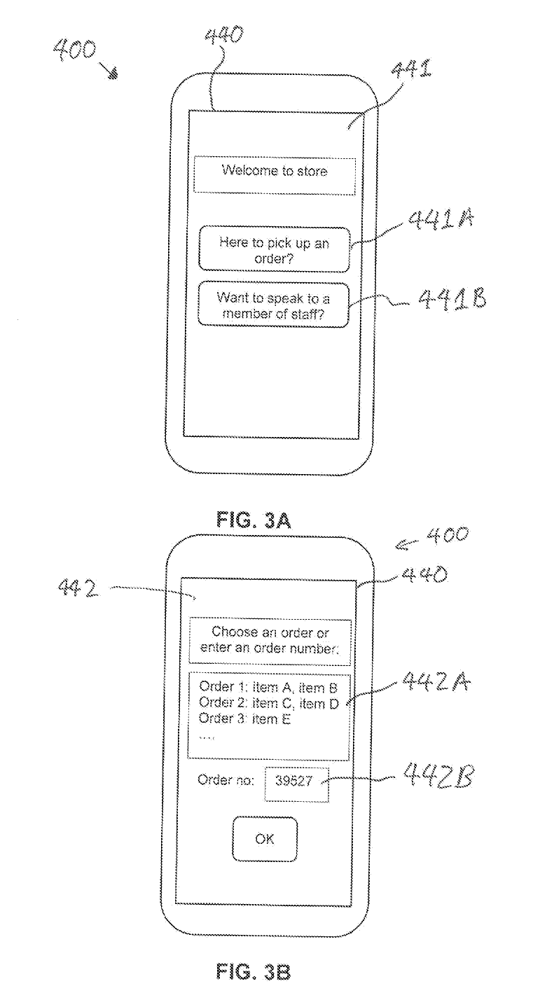

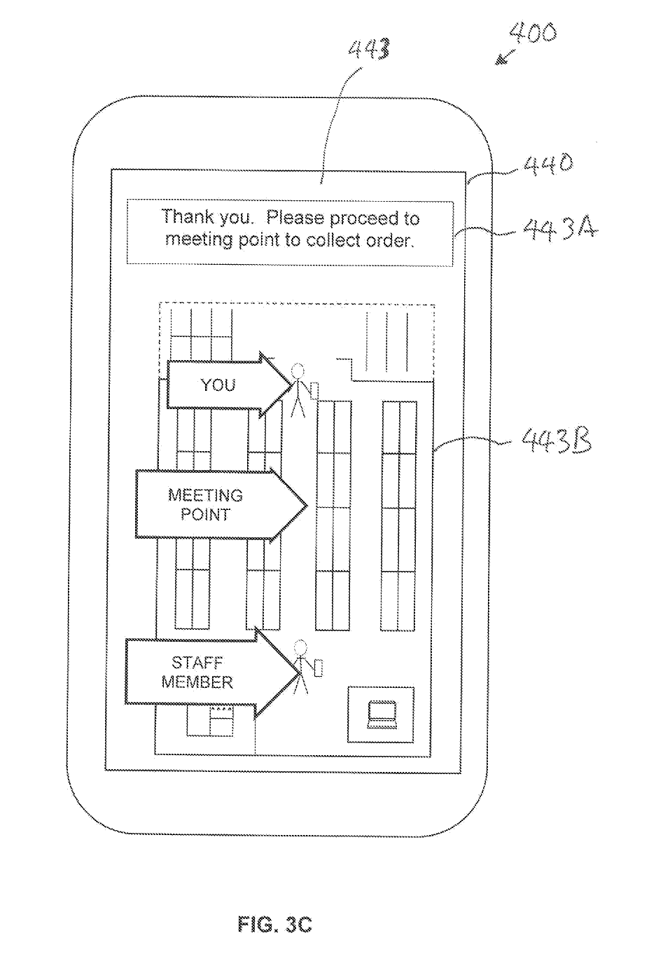

Next, the customer device 400 displays a user interface screen 441 on the user interface 440 thereof, which allows the customer 14 to indicate whether they wish to collect an order or whether they require assistance from a member of staff 13. FIG. 3A shows an example user interface 440 displaying such a user interface screen 441, which comprises a button 441A which may receive user input indicating the customer 14 wishes to collect an order and a button 441B which may receive user input indicating that the customer 14 requires assistance from a member of staff 13.

If the customer 14 selects the button 441A, the customer device 400 may display a further user interface screen 442, shown in FIG. 3B, which allows the user to indicate the order to be collected, for example by selecting from a list 442A or entering the order number manually into the region 442B. It will be understood that the list 442A could be stored on the customer device 400, or alternatively retrieved from a remote computer, for example based on the customer ID of the customer 14. The customer device 400 then transmits order pick-up information to the controller 210, based on the order to be collected.

Alternatively, if the customer 14 selects the button 441B, the customer device 400 transmits a message to the controller 210 indicating that the customer 14 requires assistance from a member of staff 13.

Next, the controller 210 generates a customer arrival notification including the determined location of the customer device 400. In examples where the controller 210 has received order pick-up information from the customer device 400, the customer arrival notification includes the order pick-up information. In one example, the controller 210 queries the order database 240 and retrieves further details of the order, and includes those further details in the customer arrival notification.

In one example, the location determiner 220 determines the location of the in-store device 300. Subsequently, the controller 210 calculates a meeting point location based on the determined location of the in-store device 300 and the determined location of the customer device 400. In such examples, the customer arrival notification includes the meeting point location.

Next, the controller 210 transmits the customer arrival notification to the in-store device 300.

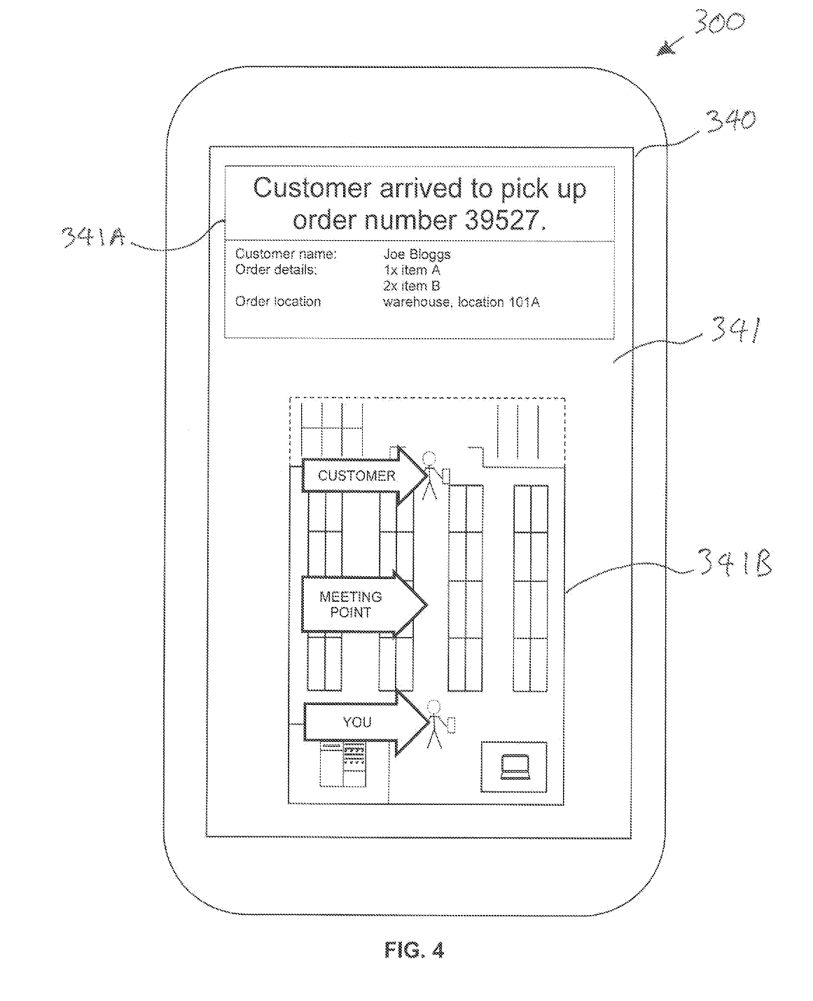

Next, the in-store device 300 displays a user interface screen 341 on the user interface 340 thereof, based on the received customer arrival notification. An example user interface screen 341 is shown in FIG. 4. The user interface screen 341 includes a region 341A which displays details regarding the order and/or the customer. Accordingly, the member of staff 13 is able to retrieve the order and verify the identity of the customer 14 based thereon. The user interface screen 341 also includes a region 341B which displays the determined location of the customer device 400. In examples where the customer arrival notification includes a meeting point location, the region 341B also displays the meeting point location. In one example, the determined location of the customer device 400 and/or the meeting point location are displayed on a map of the retail store 10. The current location of the in-store device 300 may also be displayed on the map.

In one example, the controller 210 generates an entry confirmation. The entry confirmation confirms that the message has been successfully received from the customer device 400. In one example, the entry confirmation comprises the location of the in-store device 300. In examples where the location determiner 220 has calculated a meeting point location, the entry confirmation may comprise the meeting point location.

Next, the customer device 400 displays a user interface screen 443, based on the received entry confirmation. FIG. 3C shows an example of the user interface screen 443. The user interface 443 includes a region 443A indicating that the message has successfully been received. In the example shown in FIG. 3C, the region 443A refers to the collection of an order, but it will be understood that, in examples where the message from the customer device 400 indicated that the customer 14 required assistance from a member of staff 13, an appropriate message may instead be displayed.

The user interface screen 443 also includes a region 443B which displays the location of the in-store device 300. In examples where the entry confirmation includes a meeting point location, the region 443B also displays the meeting point location. In one example, the location of the in-store device 300 and/or the meeting point location are displayed on a map of the retail store 10. The current location of the customer device 400 may also be displayed on the map.

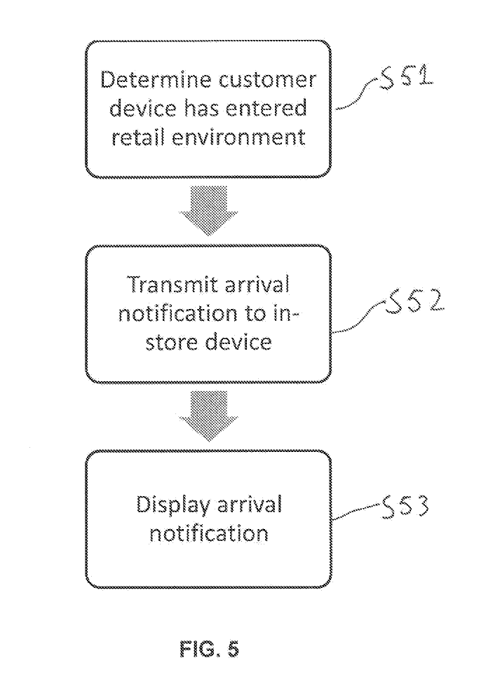

FIG. 5 is a flowchart of an exemplary method of monitoring customer movement in a retail environment.

The method includes the step S51 of determining that a customer device has entered the retail environment. In one example, the location determiner 220 of the server 200 described above determines the location of the customer device, and then determines if that customer device is within the retail environment.

The method includes the step S52 of transmitting an arrival notification to an in-store device. In one example, the in-store device is the in-store device 300 described above. In one example, the controller 210 of the server 200 transmits the arrival notification. In one example, the arrival notification comprises the determined location of the customer device. In one example, the arrival notification comprises order pick-up information received from the customer device.

The method includes the step S53 of displaying the arrival notification on the in-store device 300.

The above-described systems and methods may advantageously provide an efficient mechanism for facilitating the collection of orders by customers. Advantageously, a member of staff may be conveniently alerted to the arrival of a customer wishing to collect an order. Accordingly, the retrieval of the order may be triggered by the customer entering the store, rather than the customer presenting themselves at a predetermined order collection point.

The above-described systems and methods advantageously provide a convenient means of a member of staff locating a customer, and vice versa, within the retail store. Advantageously, a mutually convenient meeting point may be established, thereby saving time and effort expended by both the customer and the relevant member of staff.

Advantageously, the above-described systems and methods take advantage of the increased availability of portable devices such as smart phones, and improvements in indoor positioning technology.

It will be appreciated that retail store staff and customers may have a wide variety of skills and backgrounds, and the above-described embodiments provide a simple and intuitive system which may be operated with minimal training.

1. A system for monitoring customer movement in a retail environment, comprising:
a location determiner configured to determine a location of a customer device in the retail environment;
an in-store device configured to be operated by a member of staff, and configured to receive and display a customer arrival notification, and
a controller configured to, when the location determiner determines that the customer device has entered the retail environment, transmit a customer arrival notification to the in-store device.

2. The system of claim 1, wherein the customer device is configured to receive and display an entry confirmation notification, and
the controller is configured to, when the location determiner determines that the customer device has entered the retail environment, transmit the entry confirmation notification to the customer device.

3. The system of claim 2, wherein the entry confirmation notification comprises a meeting point location and the customer device is configured to display the meeting point location on a map of the retail environment.

4. The system of claim 3, wherein the controller is configured to calculate the meeting point location based on the determined location of the customer device and a location of the in-store device.

5. The system of claim 2, wherein the location determiner is further configured to determine a location of the in-store device in the retail environment, and
the entry confirmation notification comprises the determined location of the in-store device.

6. The system of claim 5, wherein the customer device is configured to display the determined location of the in-store device on a map of the retail environment.

7. The system of claim 1, wherein the controller is configured to receive order pick-up information from the customer device, and customer arrival notification comprises the order pick-up information.

8. The system of claim 1, wherein the customer arrival notification includes the determined location of the customer device.

9. The system of claim 8, wherein the in-store device is configured to display the determined location of the customer device on a map of the retail environment.

10. The system of claim 1, wherein the location determiner comprises:
a plurality of emitters operable to emit modulated light, and
a receiver operable to measure a quantity of modulated light received from each respective emitter, so as to determine the location,
wherein the customer device comprises the receiver.

11. A method of monitoring customer movement in a retail environment, comprising:
determining that a customer device has entered the retail environment;
transmitting a customer arrival notification to an in-store device configured operated by a member of staff, and
displaying the customer arrival notification on the in-store device.

12. The method of claim 11, further comprising:
transmitting an entry confirmation notification to the customer device, and
displaying the entry confirmation notification on the customer device.

13. The method of claim 12, further comprising:
determining a location of the in-store device in the retail environment,
wherein the entry confirmation notification comprises the determined location of the in-store device.

14. The method of claim 13, further comprising displaying the determined location of the in-store device on a map of the retail environment, on the customer device.

15. The method of claim 11, further comprising receiving order pick-up information from the customer device,
wherein the customer arrival notification comprises the order pick-up information.

16. The method of claim 11, wherein the customer arrival notification includes a location of the customer device.

17. The method of claim 16, further comprising:
displaying, on the in-store device, the location of the customer device on a map of the retail environment.
